(19) United States
(12) Patent Application Publication
(10) Pub. No.: US 2004/0245744 A1
(43) Pub. Date: Dec. 9, 2004

(54) Adjustable vehicle

(76) Inventors: Andrew Emang, Corvallis, OR (US); Ryan Goodwin, Corvallis, OR (US); Paul Atwood, Corvallis, OR (US); Christopher Sautter, Portland, OR (US); Paul O'Connor, Portland, OR (US); Richard Jeli, Portland, OR (US)

Correspondence Address: MARGER JOHNSON & McCOLLOM, P.C., 1030 S.W. Morrison Street, Portland, OR, 97205, US

(21) Appl. No.: 10/776,647

(22) Filed: Feb. 10, 2004

Related U.S. Application Data
(60) Provisional application No. 60/446,365, filed on Feb. 10, 2003.

(51) Int. Cl. B62K 1/00; B62K 9/00; B62J 1/00; B62C 1/00

(52) U.S. Cl. 280/281.1; 280/298; 280/63

(57) ABSTRACT

A vehicle is described that allows an operator to adjust it specifically to fit the operator's desires. A seat can be adjusted for comfort and safety by adjusting distance from pedals, and a tilt relative to the frame. A particular seat cushion can also be adjusted to the particular desires of the rider. The relative movement of vehicle frame components when the vehicle is traveling over uneven terrain can be adjusted by adjusting a suspension dampener. The steering mechanism can be adjusted for a proper fit and comfort.

### CROSS REFERENCE TO RELATED APPLICATIONS

This application claims priority from US Provisional Application 60/446,365, filed on Feb. 10, 2003, entitled “Bicycle and Accessories,” the contents of which are herein incorporated by reference for all purposes.

### TECHNICAL FIELD

This disclosure relates to a bicycle, and, more particularly, to components a seat for a bicycle that can be adjusted for rider comfort and safety.

### BACKGROUND OF THE INVENTION

Bicycles and other wheeled vehicles can be difficult or uncomfortable for some people to ride. While riding a typical bicycle, a user sits on a seat and places (or clips) his or her feet to a set of pedals that are connected to a crank. A chain connects the crank to a sprocket mounted on a drive wheel.

Hands are placed on outstretched handlebars. The rider sits on the seat and applies pressure to the pedals to cause the crank to rotate, which in turn spins a drive wheel and causes the bicycle to roll.

On a conventional diamond frame, or “upright” bicycle, the seat is generally very narrow in the front, and wider in the back. Seats are shaped this way to allow sufficient leg clearance to allow for pedaling while also providing support to the rear section of the body. Consequently, because of its shape limitations, conventional seats are not very comfortable for most people. Additionally, typical seats on upright bicycles cannot be adjusted much from their standard position. Typical adjustments allow for a small degree of tilt and a very limited front-back adjustment, on the order of one or two inches using a variety of tools. Due to these shape and adjustment limitations, most riders experience some amount of discomfort and pain when bicycling for all but short amounts of time.

Recumbent bicycles have a different relative crank position compared to upright bicycles. Specifically, the crank is placed near the front of the recumbent bicycle such that the crank is in front of the seat, rather than under the seat in the case of an upright. Because the seat in a recumbent does not have to be shaped to allow for a downward pedaling motion, it can be sized larger than the seat for the upright bicycles. Additionally, seats for recumbent bicycles typically include a seatback, which provides support and gives comfort to the rider.

There are still problems with recumbent bicycle seats, however. Oftentimes they are difficult, and/or require specialized tools to adjust. Most of them have a fixed angle relative to the recumbent bicycle frame. Some of them are still uncomfortable. Many prior art seats cannot be affixed tight to the frame and move about easily when the bicycle is being pedaled, which is annoying and wastes effort.

Handlebar adjustments can also be difficult. Normally, the height and angles of the handlebars can be adjusted, but require standard or specialized tools to make the adjustment.

Embodiments of the invention address these and other deficiencies.

### BRIEF DESCRIPTION OF THE DRAWINGS

The description may be best understood by reading the disclosure with reference to the accompanying drawings.

FIG. 1 is a side view of a vehicle according to embodiments of the invention.

FIG. 2 is an isometric view of a seat that can be attached to the vehicle of FIG. 1.

FIG. 3 is a side cutaway view of a seat according to embodiments of the invention.

FIG. 4 is a side view of the back side of the lumbar component illustrated in FIG. 2.

FIG. 5 is an isometric view of an example rail clamp used in conjunction with a vehicle according to embodiments of the invention.

FIG. 6 is a top view of the rail clamp of FIG. 5 in an open position.

FIG. 7 is a top view of the rail clamp of FIG. 5 in a closed position.

FIG. 8 is a cutaway view of an example frame component of the vehicle of FIG. 1.

FIG. 9 is a top view of components of a rail clamp according to embodiments of the invention.

FIG. 10 is an isometric view of a tilt apparatus used in conjunction with a seat on a vehicle according to embodiments of the invention.

FIGS. 11 and 12 are side views of the tilt mechanism of FIG. 10.

FIG. 13 is a side view illustrating components of a steering section of the bicycle of FIG. 1.

FIG. 14 is a side view of a steering pivot according to embodiments of the invention.

FIG. 15 is a diagram illustrating the steering pivot according to embodiments of the invention.

FIG. 16 is a diagram illustrating the steering pivot of FIG. 15 in operation.

FIGS. 17 and 18 are diagrams illustrating the underside of the steering fork according to an embodiment of the invention.

FIGS. 19 and 20 are diagrams illustrating a fender according to embodiments of the invention.

FIG. 21 is a diagram illustrating detail of a steering extension component according to embodiments of the invention.

FIG. 22 is a diagram illustrating detail of a steering column according to embodiments of the invention.

FIG. 23 is a diagram illustrating components of a shock mounting system according to embodiments of the invention.

FIG. 24 is a diagram illustrating a clamp for use in the system illustrated in FIG. 23.

FIGS. 25 and 26 are side view illustrations of a bottom bracket assembly according to embodiments of the invention.

### DETAILED DESCRIPTION OF EMBODIMENTS OF THE INVENTION

Embodiments of the invention provide a wheeled vehicle having a multitude of adjustments for fitting the rider. Many of the adjustments may be made while operating the vehicle.

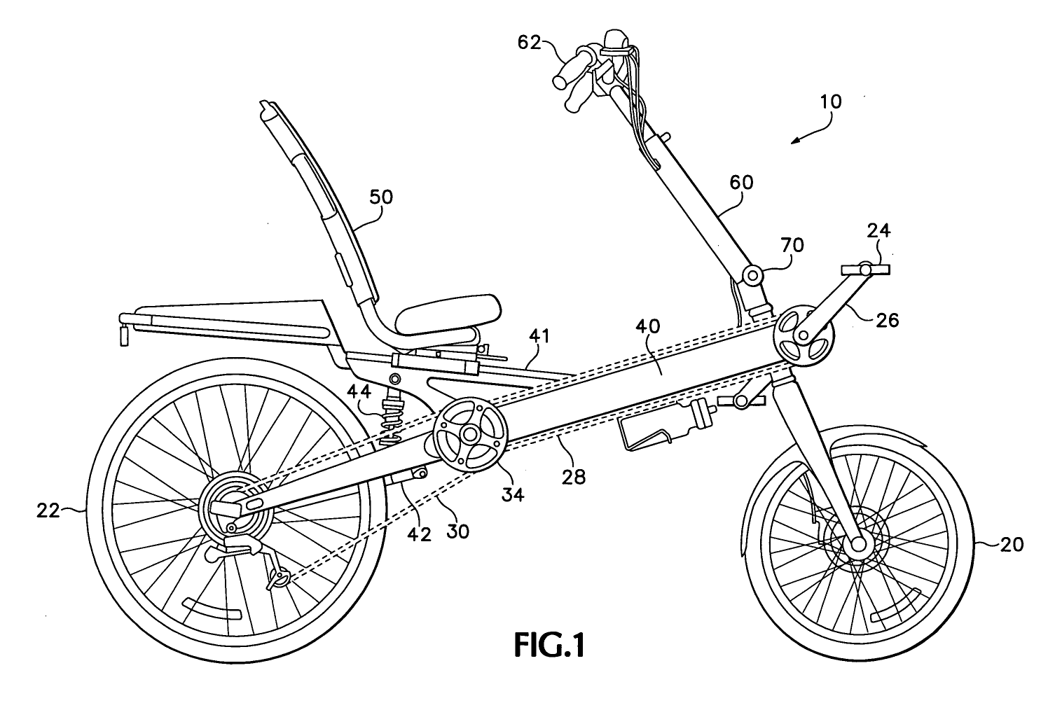

FIG. 1 illustrates a vehicle according to embodiments of the invention. In that figure, a bicycle 10 is illustrated. Components of the bicycle 10 include a front wheel 20 and a rear wheel 22 to allow the bicycle to roll. Pedals 24 and cranks 26 are coupled to a front chain 28 and a rear chain 30, and allow pedaling motion by a rider (not shown) to be translated into rolling motion of the bicycle, by driving the rear wheel 22.

A frame 40 supports most components. A lower frame member 42 is pivotally attached to the frame 40 with a shock absorber 44 mounted therebetween. The shock absorber 44 minimizes the amount of distance the frame 40 travels when the bicycle negotiates uneven terrain, and consequently reduces strain on the rider.

A seat 50 is generally upright and movably mounted to the frame 40, as discussed below. The seat 50 can be positioned in a number of ways for rider comfort.

A steering column 60 is coupled between the frame 40 and a pair of handlebars 62. The steering column 60 is positionable relative to the frame about a friction pivot 70 that can be adjusted while the bicycle 10 is in motion, as discussed below. The bicycle 10 contains other features and advantages, which will also be described below.

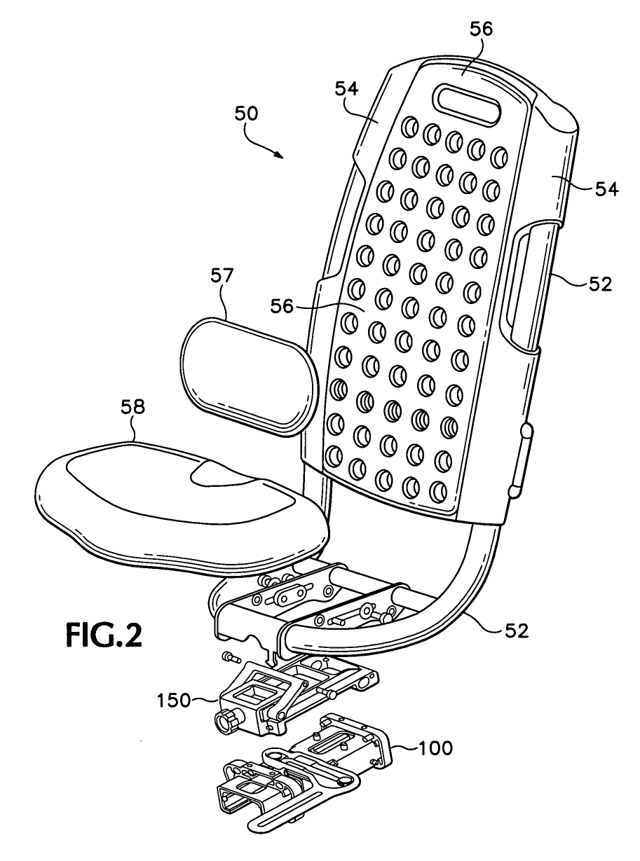

An example seat 50 is illustrated in FIG. 2. The seat 50 includes a tubular frame 52 and a backrest 54, which is attached to the frame 52.

In an example embodiment, the frame 52 includes two L-shaped frame members, which may be formed of metal or other suitably strong material, that run vertically up the sides and extend horizontally toward the front of the bicycle 10. The vertical portions of the frame 52 support the backrest 54 and the horizontal portions of the frame 52 support a seatrest 58, as described below.

The backrest 54 is attached to the frame 52. In one embodiment, the backrest 54 is formed of plastic and molded around the frame 52. Once the plastic is cured, the backrest 54 is mechanically “locked” into the frame 52 and prevented from moving. Alternatively, the backrest 54 may be attached to the frame 52 in a more conventional manner, such as by bolts or screws. The backrest 54 may also include metal components (not shown) for adding additional strength to the backrest 54. Forming the backrest 54 out of a firm material provides the rider with a stable platform to push against, which increases pedaling efficiency. Additionally, a foam backpad 56 can be integrated with or attached to the backrest 54 to provide additional comfort to the rider. The foam backpad 56 as illustrated in FIG. 2 covers the central portion of the backrest 54.

The backrest 54 may be shaped to match the curvature of the rider's back and ventilated with several holes. As shown in FIG. 2, the foam backpad 56 also includes holes, which match the holes in the backrest 54. Further, the backside of the plastic backrest 54 may include threaded holes spaced apart in standard distances, as is known in the art, for mounting bags, water bottle cages, and other accessories to the seat 50.

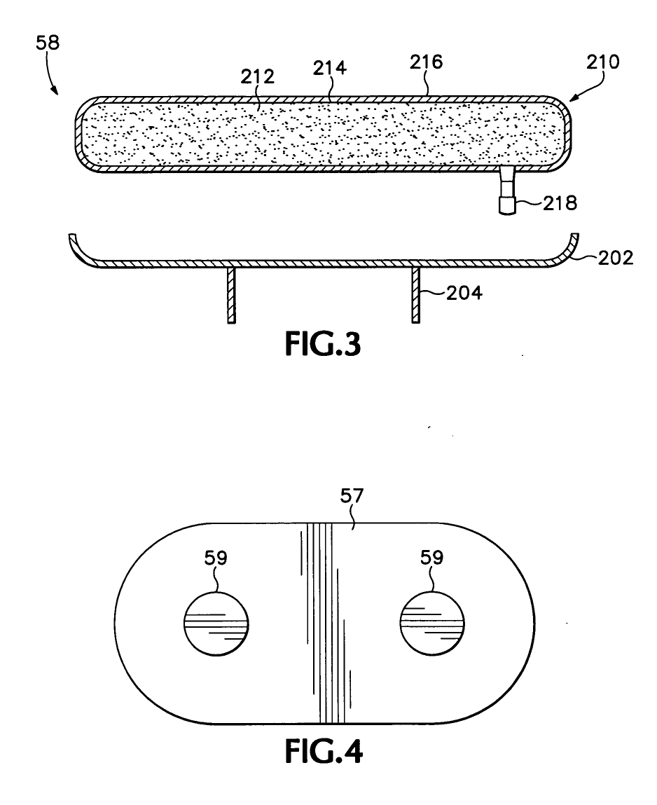

The seatrest 58 is mounted to the horizontal portion of the frame 52 and supports the rider's weight when he or she is sitting on or riding the bicycle 10. The seatrest 58 may be formed from a single piece of plastic, or other suitable material, or may be formed of multiple parts. FIG. 3 illustrates an embodiment of the seatrest 58 formed from multiple pieces.

The seatrest 58 of FIG. 3 generally includes a support 202 and a cushion 210. The support 202 includes projections 204 that can be used to attach the seatrest 58 to the frame 52. The cushion 210 is further formed of a foam core 212 surrounded by an air bladder 214 and an outer cover 216.

The outer cover 216 protects the air bladder 214 from wear, and from the elements. Air can be allowed to flow into or from the bladder 214 by operating an air valve 218. If the air valve 218 is opened, the foam core 212 causes the air bladder 214 to expand until the bladder cannot hold more air. The valve 218 can then be closed and a combination of the air bladder 214 and foam 212 provide support to the rider. Air can be removed from the air bladder 214 by providing pressure to the cushion 210 while opening the valve 218. When the valve 218 is closed, no air is able to return to the air bladder 214, and the seat cushion 210 is thereby adjusted.

The seatrest 58 is contoured to support the rider comfortably while riding and while stopped with their feet on the ground in a resting position. In some embodiments, the seat 50 further includes a lumbar pad 57, which is illustrated in FIGS. 2 and 4. The lumbar pad 57 allows riders to customize the shape of the seat back for comfort to fit their needs. The lumbar pad 57 may be formed of a foam cushion, with 2 bosses 59 on the backside. The bosses 59 are sized such that they may be inserted into the ventilation holes of the seatrest 58, and held by a friction fit. The lumbar pad 57 is also constantly being held in place when the back of the rider is pushing against it.

Additionally, the bosses 59 may be formed off-center, such that, when oriented in one direction, the lumbar pad 57 sits a little higher relative to the orientation where the lumbar pad is inverted. Further, the bosses 59 may be inserted in any of the ventilation holes, thereby changing the position of the lumbar pad 57 by choosing different ventilation holes or by changing the orientation of the lumbar pad. The seat 50 does not need the lumbar pad 57, and some riders may find it more comfortable to ride without such a pad. If the rider wishes to carry the lumbar pad 57, but not use it when riding, the lumbar pad 57 may be inserted into the ventilation holes from the rear side of the seat 50 for storage.

Referring back to FIG. 2, the seat 50 connects to the bicycle 10 through a rail clamp 100 and a tilt assembly 150. In operation, the tilt assembly 150 allows the rider to adjust the tilt of the seat 50 relative to the frame 40 (FIG. 1), even during operation of the bicycle. The rail clamp 100 allows the rider to adjust his or her distance from the pedals 24. Both the rail clamp 100 and the tilt assembly 150 are described below.

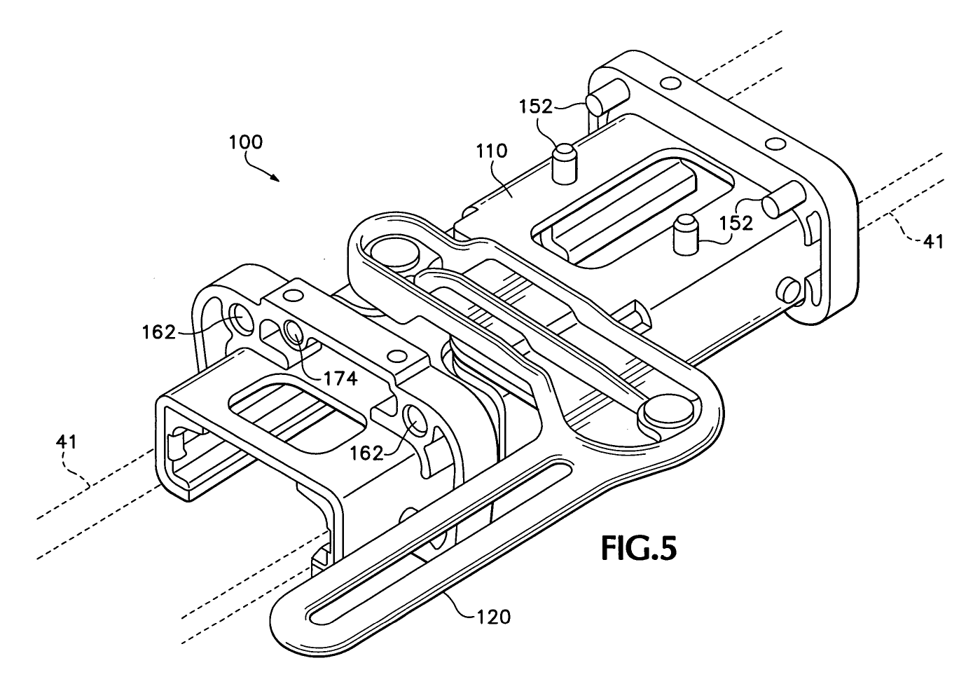

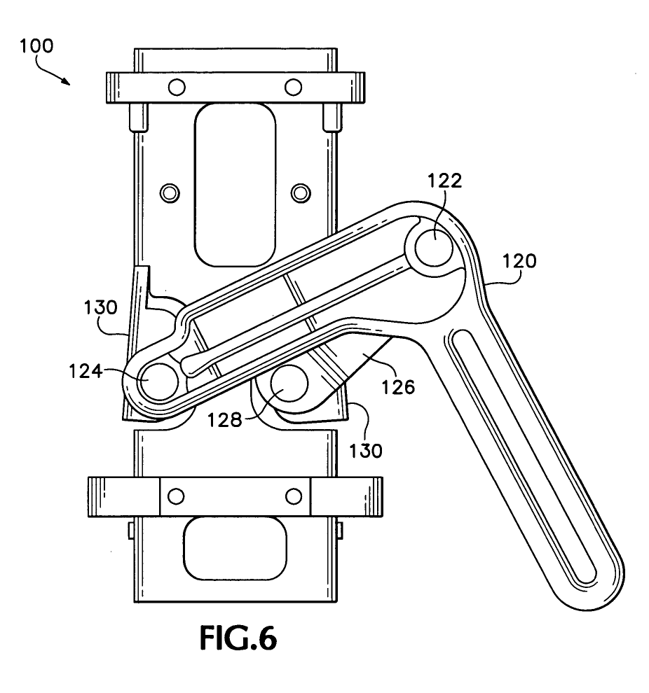

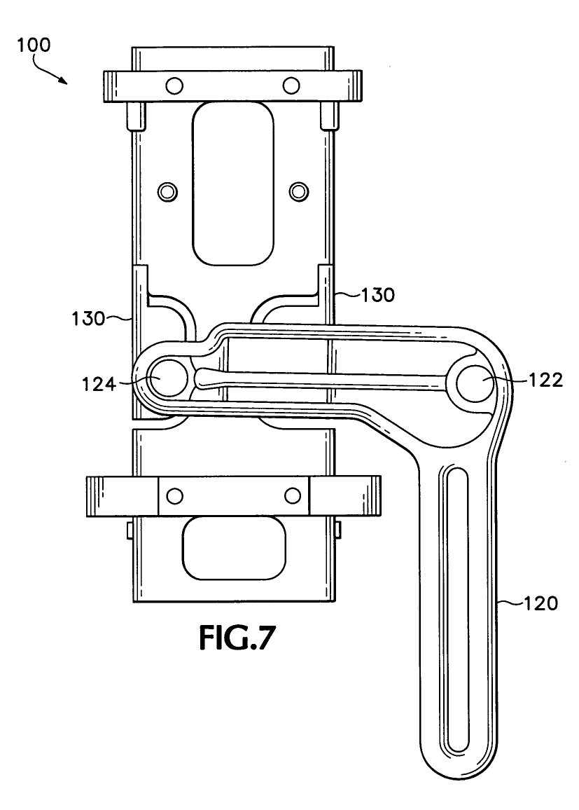

FIG. 5 illustrates how the rail clamp 100 attaches to the frame 40 at a generally flat or slightly curved shaped frame rail 41 (FIG. 1). The rail clamp 100 is formed of a generally “C” shaped body 110, which is slidably coupled over the frame rail 41 of the frame 40. The rail clamp 100 may be formed of a rigid material, such as aluminum. Lips of the C-shaped body 110 prevent the rail clamp 100 from being lifted from the frame rail 41. A handle 120 operates the rail clamp 100 into either an open position, illustrated in FIG. 6, where the rail clamp 100 can slide over the frame rail 41, or a closed position, illustrated in FIG. 7, where portions of the rail clamp 100 are frictionally held against the frame rail 41 of the frame 40.

The handle 120 of the rail clamp 100 illustrated in FIGS. 5-7 may be configured in any suitable way to enable the rail clamp 100 to be held against the frame 40. In one embodiment, as illustrated in FIG. 6, the handle 120 is generally “L” shaped, and includes pivots 122 and 124, which allow the handle 120 to move. A handle link 126 couples between the pivot 122 and a third pivot 128. In this configuration, the handle 120 and handle link 126 operate in a cantilevered fashion, applying force to both sides of the rail clamp 100 but being able to be operated from only a single side of the bicycle 10. In this embodiment, the handle link 126 has a length that is approximately two-thirds the distance between the pivots 122 and 124. Of course, the relative lengths of the handle 120, handle link 126, and the distance between the pivots 122, 124, 128 are related to the physical dimensions of the rail clamp 100 and the frame rail 41 of the bicycle 10.

In operation, as illustrated in FIG. 6, as the handle 120 is opened, it forces movable portions 130 of the rail clamp 100 outward, and away from the frame rail 41. This allows the rail clamp 100 to slide along the frame rail 41 such that the rider can adjust his or her distance from the pedals 24. When in a locked position, as illustrated in FIG. 7, the movable portions 130 of the rail clamp 100 are forced inward, providing a clamping force against the frame rail 41, which keeps the seat 50 (FIG. 1) in place on the bicycle 10. The movable portions 130 of the rail clamp 100 can be made to move by any acceptable manner. In one embodiment, a portion of a side and top of the body 110 is removed to lessen the rigidity of the rail clamp 100 in those areas. This is illustrated in FIG. 6. In that figure, the moveable portion 130 includes the portion where the pivots 122 and 124 attach to the rail clamp 100.

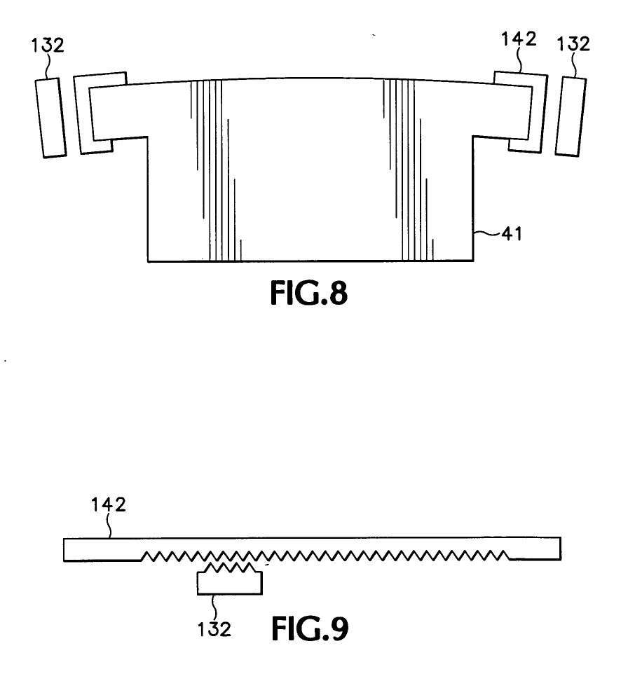

To further enhance the grabbing force of the pads against the bicycle frame, a set of knurled rails can be attached to the frame to give the rail pads additional surface area to mate with FIG. 8 illustrates a set of rail pads 132 and a set of seat rails 142. To increase frictional force provided by the rail clamp 100, rail pads can be attached to the rail clamp 100. In the illustrated embodiments, the rail pads are attached to the movable portion 130 of the rail clamp 100. The rail pads, when pressed by the movable portions 130 of the rail clamp 100, apply frictional force to the frame rail 41, which causes the seat 50 to be locked into place. Only the rail pads 132 of the rail clamp 100 are illustrated in FIG. 8, and not any other portion of the clamp. Additionally, a set of seat rails 142 are illustrated as covering the lateral surfaces of the frame rail 41. In this embodiment, the set of seat rails 142 are generally C-shaped, and may be attached to the frame rail 41 in an appropriate matter, for instance with epoxy. The seat rails 142 may extend nearly the entire length of the frame rail 41, which gives a rider a great amount of latitude in setting the seat-to-pedal distance.

FIG. 9 is a top view of the rail pads 132 meshing with one of the seat rails 142. In this embodiment, both surfaces 132, 142 have knurling, or bumps, which provides a very strong clamping surface when the rail clamp 100 is closed. Specifically, the mechanical mating of the knurling of the seat rails 142 with the knurling on the rail pads 132 gives a quasi-lateral interface surface, which is extremely resistant to slipping if the rail clamp 100 is in the clamped position. In other words, with this enhanced mechanical interface due to the knurled surfaces, a very large amount of pushing force is required to move the seat 50 when the rail clamp 100 is in the clamped position. Thus, the seat 50 does not slip backward along the frame rail 41 when the rider is pushing hard against the pedals 24. In one embodiment, the knurls are positioned 0.033″ apart from one another, which provides a very fine adjustment. Of course, other knurling spacing could be used. Additionally, knurling is only one way to modify the mechanical interface between the seat rails 142 and the rail pads 132, and other acceptable methods can be used, such as roughing, scratching, etc.

In some embodiments, the seat rails 142 can be made of aluminum, or anodized aluminum, while the rail pads 132 can be made from aluminum or other acceptable material. It is preferable that the rail pads 132 be made from a softer material than the seat rails 142, because the rail pads 132 can be replaced more easily than can the seat rails 142. Additionally, the rail pads 132 are generally smaller, and are less costly to replace than the seat rails 142.

With reference back to FIGS. 6 and 7, operation of the rail clamp 100 will now be discussed. As described above, the rail clamp 100 includes the handle 120 and the handle link 126, assembled into an integrated cantilever arrangement. When the rail clamp 100 is closed, or clamped, as illustrated in FIG. 7, the rail pads 132 (FIG. 8) contact the sides of the seat rail 142 on the frame rail 41 and form a mechanical bond. This prevents the seat 50 from sliding along the frame rail 41. The clamping force on the rail pads 132 is provided by the handle 120 actuating the rail clamp 100 though the cantilever arrangement.

Leg reach adjustment on the bicycle 10 is accomplished by sliding the seat 50, which is connected to the rail clamp 100, along the frame rail 41 to the desired position, and clamping the rail clamp 100 into place. Closing, or clamping, the rail clamp 100 forces the clamp mechanism to toggle overcenter and to hold the rail pads 132 in contact with the seat rails 142 with sufficient force to prevent sliding, as illustrated in FIG. 7. The overcenter action of the handle 120 also locks the rail pads 132 in the clamped position. Additionally, a mechanical stop may be created by designing the handle 120 to interfere with the handle link 126. This mechanical stop provides a stop for the handle 120 to reset against when the rail clamp 100 is in the clamed position, and to prevent too much over-travel by over centering the handle 120, which would reduce the clamping force of the rail pads 132. To move the seat 50 along the frame rail 41, the handle 120 is pulled away from the center of the bicycle 10, which releases the rail pads 132 and separates them from the seat rail 142. This allows the rail clamp 100 to slide easily along the seat rail.

To further ease the travel of the rail clamp 100 over the frame portion 41, plastic bushings or sliders can be inserted into the top, sides, and/or bottom of the rail clamp 100 (not shown because internal). In this manner, the rail clamp 100 is always sliding on the plastic bushings over the seat rail 142, and there is no metal to metal contact. Additionally, the seat rail 142 may be polished on the top and bottom surfaces to allow easy sliding of the rail clamp 100 when in the unclamped position.

Permanent marks may be made on a top portion of the frame rail 41, which allows the rider to see the position of the seat 50 relative to the frame rail 41.

As mentioned above, the rail clamp 100 is relatively permanently mounted to the frame rail 41 by virtue of its shape. A tilt assembly 150 (FIG. 2) interfaces between the rail clamp 100 and the seat 50 itself.

The tilt assembly 150 allows the rider to adjust the tilting angle of the seat 50 without using tools. The adjustment can be made while riding the bicycle 10.

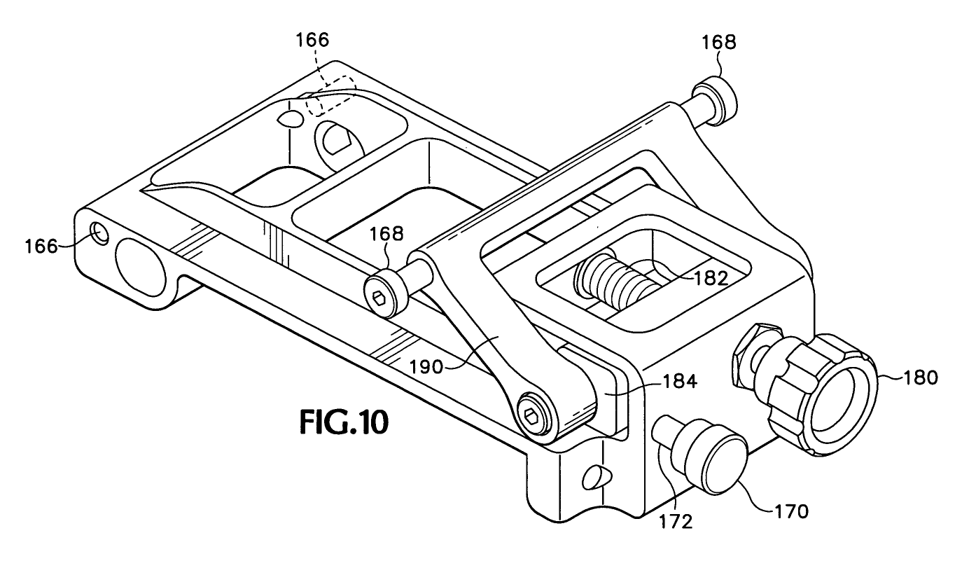

The tilt assembly 150 can connect to the rail clamp 100 with a quick release mechanism to make it relatively easy to remove the seat 50 from the bicycle 10. As illustrated in FIGS. 5 and 10, small posts, or nubs 152 can mesh with and be inserted into properly sized receivers 162. A pair of receivers 162 is shown in FIG. 4, which accept a pair of nubs 152 attached to the tilt assembly 150 of FIG. 9. The nubs 152 are not illustrated in FIG. 10 because they are obscured, but are located on the inside surface of the portion of the tilt assembly 150 nearest a set of knobs 170, 180. To interface the tilt assembly 150 with the rail clamp 100, the tilt assembly 150 is positioned such that the nubs 152 are near their respective receivers 162. In such a position, the knob 170, which is attached to a threaded rod 172 may be turned. The threaded rod is inserted into a threaded hole 174 (FIG. 5), which accepts the threaded rod 172. Turning the knob 170 inserts the threaded rod into the threaded hole 174, and the nubs 152 are simultaneously inserted into their respective receivers 162. When the tilt assembly 150 cannot travel further, the threads on the rod 172 and in the hole 174 create mechanical interference, and the tilt assembly is held tight to the rail clamp 100. Of course, other methods for attaching the tilt assembly 150 to the rail clamp 100 are possible, and with the ability of one skilled in the art.

As shown in FIG. 2, the tilt assembly 150 is further attached to the frame 52. Holes 166 (FIG. 10) of the tilt assembly 150 accept threaded shoulder bolts (not shown), which are passed through respective holes in the frame 52. Another set of shoulder bolts are illustrated as 168, which pass through additional holes in the frame 52. These bolts 168 allow a tight fit between the tilt assembly 150 and the frame 52 while still allowing travel for seat tilting adjustments. In some embodiments the tilt assembly 150 can adjust between zero and ten degrees relative to the frame 40.

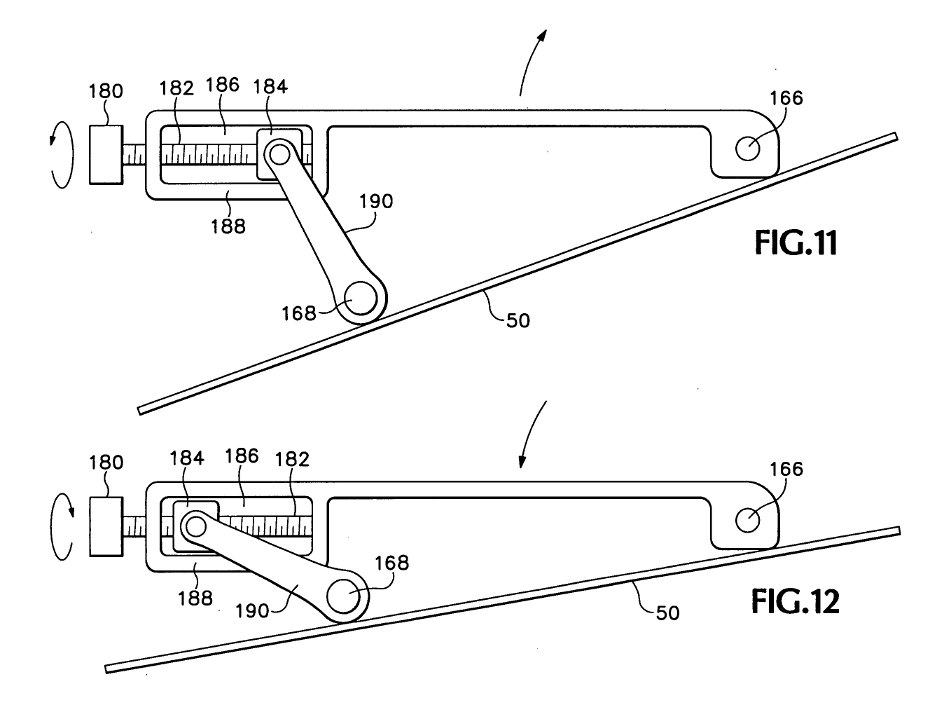

As shown in FIGS. 10-12, the tilt assembly 150 allows the seat 50 to be tilted by rotating the adjustment knob 180. For clarity, FIGS. 10 and 11 illustrate the tilt assembly 150 in a position inverted from its typical position when mounted on the bicycle 10.

The bolts 168 and holes 166 are fixed to the frame 52, which in turn is fixed to the seat 50. The distance between the bolts 168 and holes 166 is static, i.e., does not change as the adjustment knob 180 is moved.

A tilting arm 190 is mounted between the bolts 168 and a sliding block 184. The sliding block 184 is threaded to receive therethrough a captured screw 182 that is connected to the adjustment knob 180. The sliding block 184 is able to move within a slot 186, formed by a frame 188, but the sliding block 184 cannot travel out of the slot 186 in its standard operation. Rotating the knob 180 and the screw 182 causes the sliding block 184 to travel within the slot 186. Because the distance between the bolts 168 and holes 166 is fixed, and because the length of the tilting arm 190 is also fixed, the tilt assembly 150 is limited in its movements. Therefore, rotating the knob 180 causes the tilt assembly 150 to pivot about an axis through the center of the holes 166.

In some embodiments, the screw 182 is made from steel and the sliding block 184 is made from aluminum bronze 954 alloy. This combination allows the tilt assembly to make precise and accurate adjustments while also remaining relatively easy to turn. The remainder of the body of the tilt assembly 150 may be made from aluminum, or other likewise strong material, to provide necessary support to the bicycle seat 50.

The particular geometry of the tilt assembly 150 allows the rider of the bicycle 10 to make a secure, precise, and relatively easy tilt adjustment for the seat 50 relative to the frame 40. The tilt adjustment can be made by one hand. Additionally, mounting the control knob 180 toward the front of the seat 50 allows the rider to adjust the tilt of the seat 50 even while riding the bicycle. The seat angle adjustment is independent of other seat adjustments and not affected if the seat is removed from the bicycle 10. Permanent marks can be made on the frame 52 so that the amount of tilt can be measured.

FIGS. 1 and 13 illustrate, in general, the adjustable steering assembly and friction pivot 70 used in embodiments of the invention. The steering assembly provides the rider to ability to adjust the handlebars 62 for safety and comfort and is easy to use. The rider can change the position of the steering column 60 simply by pushing or pulling on the handlebars 62, even while the bicycle 10 is in motion. Further, the steering assembly may be adjusted without using any tools.

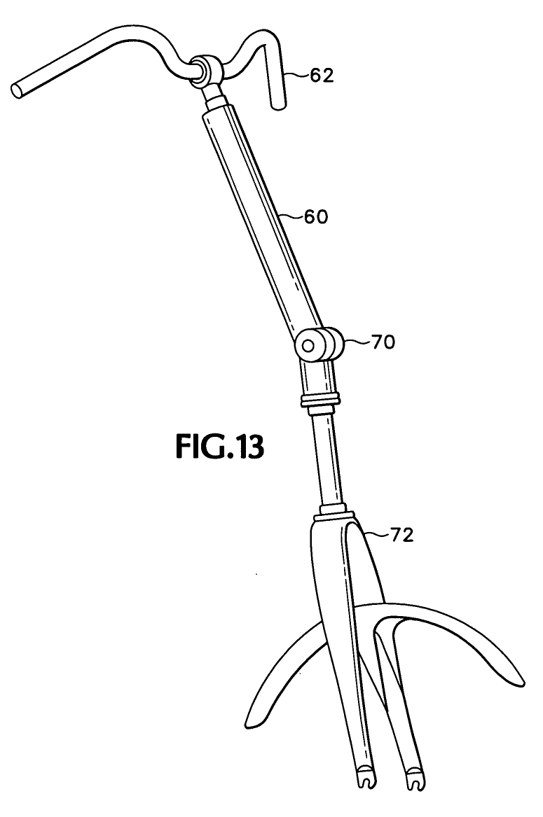

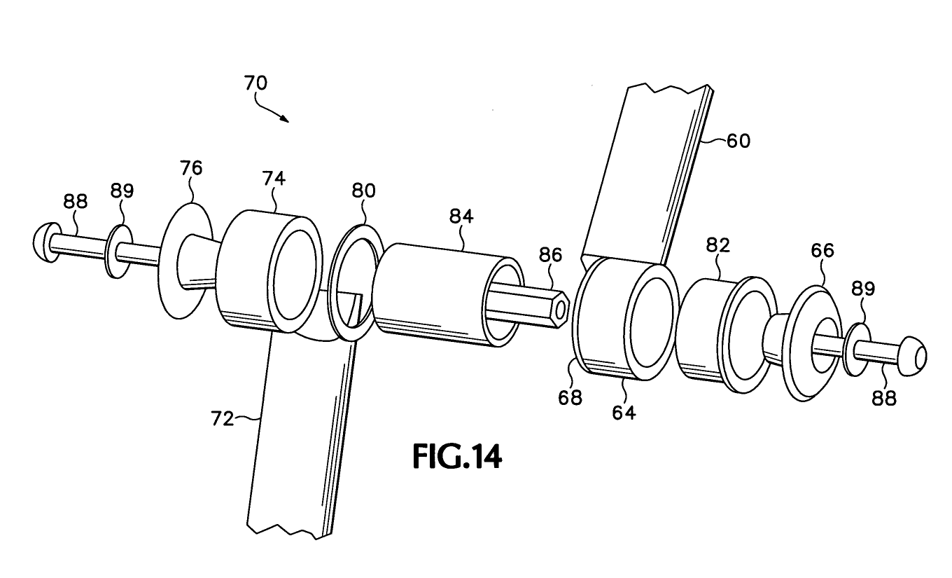

FIG. 14 illustrates example components that can be used in the friction pivot 70. An upper pivot 64 is bonded or otherwise attached to the steering column 60, such as by welding or other attachment method. Thus, the steering column 60 and upper pivot 64 are integrated and operate as a single unit. A lower pivot 74 is bonded or bolted to a fork 72. The fork 72, as shown in FIG. 1, supports the front wheel 20 of the bicycle 10.

An internal pivot tube 84 extends through the upper pivot 64 and lower pivot 74. A pivot bearing 82 inserts within the upper pivot 64 and slides over the pivot tube 84. In some embodiments, the pivot tube 84 is made from aluminum, and the pivot bearing 82 is a polymer bearing with integrated lubricants available from Igus, Inc. of Providence, R.I. This combination of the pivot bearing 82 sliding over the pivot tube 84 ensures a reliable, long-lasting, smooth moveable joint.

The pivot tube 84 also provides support for a friction disk 80 and a washer 68. In some embodiments, the friction disk 80 may be attached to the lower pivot 74, such as by glue or epoxy, and the washer 68 may be attached to the upper pivot 64, or may simply float between the friction disk 80 and the inside surface of the upper pivot 64. Not all components are required for all embodiments.

The friction disk 80, when properly positioned, applies a frictional force to the upper pivot 64 and lower pivot 74. The friction disk 80 may be made from a clutch material or a semi-metallic brake lining material. For instance, the brake lining material may be phenolic treated brass wire inserted in cloth which is laminated under pressure to a dense composite, and known as “AFT #200, cf=42” from Advanced Friction Technology of Portland, Oreg., or other acceptable substitute.

In one embodiment, adjustments to the friction pivot 70 are made through the combination of a coupling screw 86, which runs through the friction pivot 70, and a pair of attachment screws 88, which thread into the coupling screw 86. Caps 66 and 76 are held into place by the attachment screws 88 and washers 89, and/or a friction coupling with the coupling screw 86. Tightening one or both of the attachment screws 88 brings the upper pivot 64 and lower pivot 74 closer to each other, and causes a greater amount of frictional force to be applied to the friction disk 80. Loosening the attachment screws 88 from the coupling screw 86 decreases the force on the friction disk 80, and allows the friction pivot 70 to slide with a lesser amount of force. Once adjusted, the steering column 60 can be moved by the rider without use of any tools, simply by pushing or pulling the handlebars 62. Using this method, the force required to move the steering column 60 may be adjusted between, for example, 11b to 751b of force at the handlebars 62.

The upper pivot 64 may include a ledge or extension to provide a hard stop at the end of handlebar 62 rotation. The hard stop mates with the lower pivot 74. Additionally, the handlebar rotation stop may be set to interfere with rotation only in one direction, thus the steering column 60 could rotate in the other direction without limitation until the stop was reached by rotating the handlebars 62 all the way around to reach the stop from the other direction. Thus, by combining the ability to move the steering column 60 about the pivot 70 with the ability to rotate the handlebars 62 over a wide range allows the steering column 60 be positioned close to the frame 40 for compact storage, or for shipping. To so position the steering column 60, first, the steering column 60 is pushed away from the seat 50 to cause it to arc about the steering pivot 70. Next, the steering column 60 is rotated around 180 degrees such that it aligns with and is adjacent to the frame 40. As described below, the handlebars 62 can also be rotated within the steering column 60. This reduces the overall size of the bicycle 10 for storage or transport. Because of the friction disk 80 in the steering pivot 70, the steering column 60 will stay in this position until otherwise moved.

As illustrated in FIGS. 15 and 16, a cable 90, such as a front brake cable, may be routed through the forks 72 and steering column 60 and around the friction pivot 70. The steering column 60 may be scalloped, or otherwise formed to include a hole to accept the cable 90. Likewise the forks 72 may include a hole or bore 92 through which the cable 90 can pass. By routing the cable through the forks 72 and steering column 60, twisting and bending of the cable 90 can be avoided.

The lower pivot 74 includes the bore 92 for the cable behind the friction pivot 70, as illustrated in FIGS. 15 and 16. This bore 92 allows the cable 90 to translate through when pivoting the steering column 60 about the friction pivot 70. Extra slack for the cable 90 is kept near the brake handle itself. The bore 92 prevents the cable 90 from interfering with the other mechanisms within the lower pivot 74 and steering column 60.

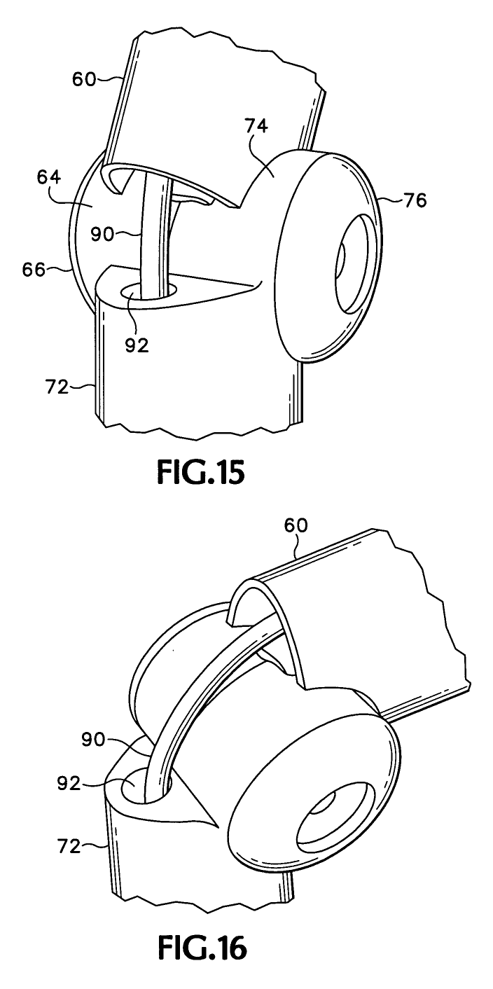

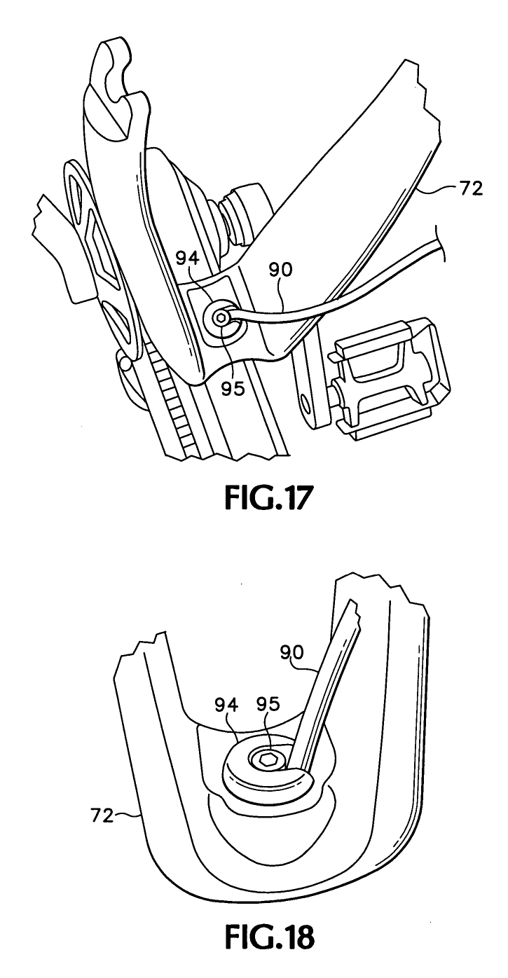

On the underside of the fork 72, as illustrated in FIGS. 17 and 18, the cable 90 exits alongside a bolt head 95 and through a bolt cap 94. This design allows the fork 72 to rotate infinitely about a 360 degrees range without causing binding of the cable 92. In one embodiment, the bolt cap 94 includes a slot, for example 5.5 mm, to allow passage of the cable 90 and the bolt. The bolt cap 94 also includes a 9 mm counter machining to capture the bolt head 95 for preloading.

The bold head 95 illustrated in FIGS. 17 and 18 functions as the headset cap, and is unusual because it may be placed on the underside of the fork 72, which is the opposite of other bicycle designs.

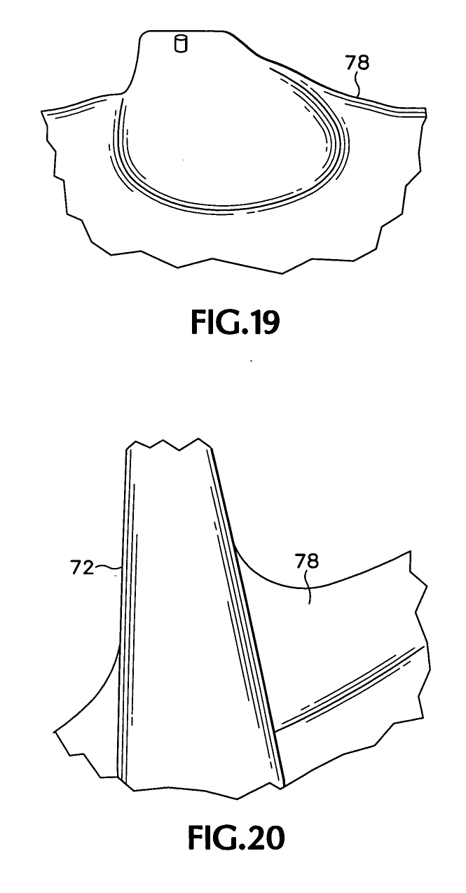

FIGS. 19 and 20 illustrate a front fender 78 and how it can be attached to the front fork 72. In some embodiments, the front fender 78 can be formed of carbon fiber for strength, durability and light weight. The fender 78 is shaped to mate closely with the shape of the fork 72, which constrains and gives the fender 78 additional support.

The fender 78 has two “fingers” or sides that mate to the front fork 72 with nearly identical geometry to the fork 72. The two fingers of the fender 78 may be formed to be, effectively, spring components which apply outward pressure on the blades of the fork 72 when the fender 78 is installed on the fork. This ensures a snug fit of the fender 78 to the fork 72, and eliminates any slop or rattle that could develop. A small rivet or screw may be installed into the fork 72 which mates with holes in the fender 78 to attach the fender 78. The fender 78 may be mounted without tools by sliding the fender 78 up into the fork 72 from the bottom. The fingers of the fork 78 are then compressed and the fender 78 is slid further up the fork 72 until it stops and mates with the rivets by snapping the rivets or screw heads into the holes in the blades of the fender 78. This provides a very rigid, stable mount, which allows the fender 78 to be mounted very close to the front wheel 20. A more traditional mounting could be used where a screw is inserted through a hole in the fingers of the fender 78, and screwed into the body of the fork 72 itself.

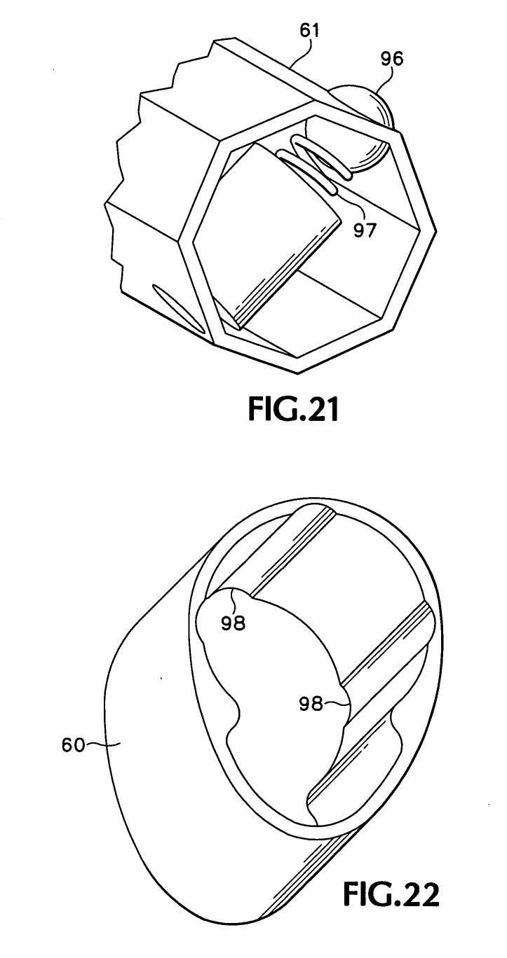

Another aspect of the invention is ensuring proper steering alignment of the handlebars 62 and the front wheel 20. Such alignment may be maintained with a ball-detent mechanism, as illustrated in FIGS. 21 and 22.

In FIG. 21, a steering extension 61, or gooseneck is illustrated. Generally, the extension 61 inserts into the steering column 60, illustrated in FIG. 22. Within the steering column 60 are one or more detents 98 that run along the length of the steering column 60. The longer the detents 98 are within the steering column, the more guided range of handlebar 62 adjustment height is available within the steering column 60.

Attached to the extension 61 is a ball 96 and spring 97. In one embodiment, the ball 96 has a diameter of ⅜″ and is made from steel. In operation, as the handlebars 62 (which are directly coupled to the extension 61) rotate within the steering column 60, the ball 96 is pushed into one of the detents 98 by the spring 97. With further turning force applied to the handlebars 62, the ball 96 will overcome the force of the spring 97 and pop out of the detent 98. The ball 96 will then travel, as more turning force applied, until it reaches the next detent 98. The number of “positions” or pre-set stops in the handlebars 62 is determined by the number of detents 98 formed in the steering column 60. In one embodiment, 3 detents 98 are formed—one such that the handlebars 62 are pointing straight, one 90 degrees to the left and one 90 degrees to the right. This allows quick and easy storage of the handlebars 62 by rotating them 90 degrees in either direction to align them with the body of the frame 40 of the bicycle 10.

By creating another detent or lip that runs around the perimeter of the steering column 60, the ball 96 can also operate as a maximum height limiter for the handlebars 62. The ball 96 stops the steering extension 61 from extending any further out of the steering column 60 than the minimum insertion mark.

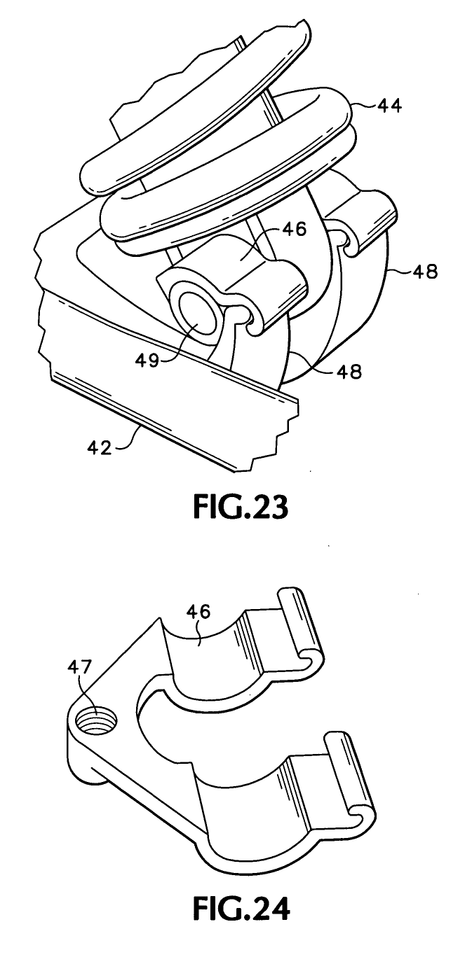

FIGS. 23 and 24 illustrate another embodiment of the invention which provides the user with another way to individually adjust the bicycle 10. Specifically, these figures illustrate how an adjustable shock 44 may be mounted to the frame 40 of the bicycle 10. The shock 44 may be adjusted for rider comfort to be more or less stiff, and change the compression/release characteristics.

As mentioned above, the shock absorber 44, or shock, limits travel of the frame 40 when the bicycle 10 is traveling over uneven terrain by allowing the lower frame member 42, or “swingarm” to move and “absorb” the bumps.

A typical shock absorber has a through-bolt design which uses a bolt and nut to secure the end of the shock absorber. There are times when it is inconvenient or unsightly to include a through-bolt, however. In those situations, another method must be used to secure the shock absorber to its suspension component.

As illustrated in FIG. 23, the lower frame member 42 includes a shock frame mount 48. The frame mount 48 may be welded or otherwise attached to the lower frame member 42.

A shock mount clamp 46, illustrated in FIGS. 23 and 24 mounts to the frame mounts 48 and provides a single threaded hole 47 for attaching the clamp 46. Note that, compared to other shock mounting apparatuses, the shock mount clamp 46 only uses as single bolt, where prior art mounts used a bolt and nut. Additionally, the bolt that attaches through the hole 47 is directioned along the long axis of the shock 44, rather than transverse to it in other mounts. This frees up design constraints for the shock designer. The design of the clamp 46 allows the shock 44 to be secured with a hook on one side of the shock frame mounts 48, and is clamped using one bolt accessed from the underside of the lower frame member 42.

In one embodiment, the clamp 46 utilizes a hook design with a 1.3 mm radius that mates with tabs on the shock frame mount 48. The clamp 46 is split with a gap of approximately 14.5 mm to allow clearance for the body of the shock 44. The clamp 46 has a shock bushing cradle that mates with a shock bushing 49 that is attached through the transverse through hole in the shock 44. The diameter of an example shock bushing 49 is 12 mm.

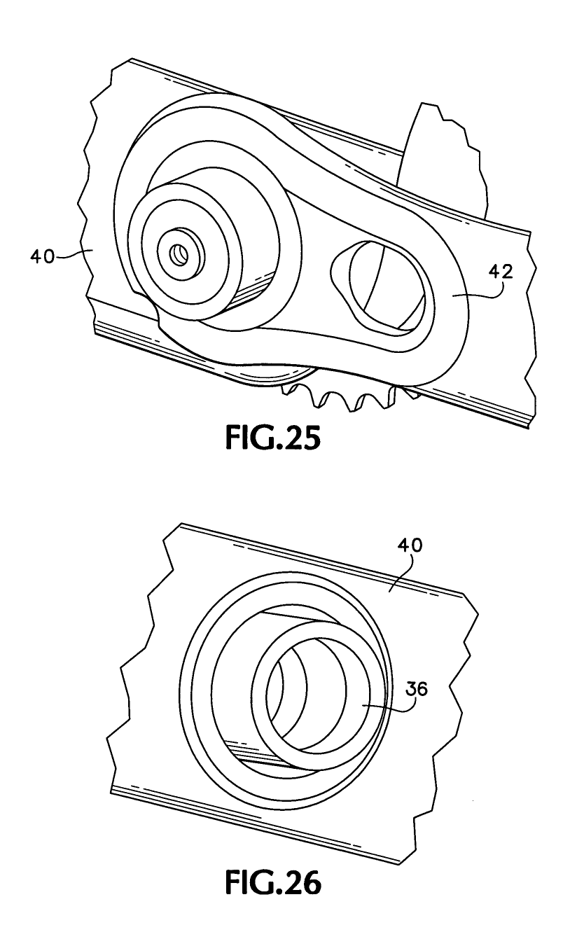

FIGS. 1, 25, and 26 illustrate a bottom bracket pivot shell. The pivot shell describes the area where the frame 40 meets the lower frame member 42, and where a mid-drive chain ring 34 is mounted. Additionally, the pivot serves as the main rotation area for the suspension of the bicycle 10. The pivot shell provides a hard, smooth surface for pivot bearings 36 to ride against during suspension compression.

The pivot shell may include internal threads to provide for a mounting of a standard bottom bracket assembly. This assembly is then installed through the lower frame member 42, frame member yokes, a main pivot bore and pivot bearings 36. The outside of the pivot shell may be polished to a tolerance of 1.75″, and then anodized to provide a smooth, hard gliding surface to interface with the pivot bearings 36.

This configuration allows the maximum possible bearing surface for this suspension design. It works especially well in situations where the suspension pivot is in the same location on the frame 40 as the drivetrain components.

Embodiments of the invention shown and described herein are not limiting to the invention itself, and the inventive concept of this invention is meant to be considered broadly.

What is claimed is:

1. A vehicle, comprising:
a frame structured to support at least two wheels;
a seat assembly; and
a rail clamp attachable to the seat assembly and slidably connected to a portion of the frame, the rail clamp including a pair of rail pads for clamping against the frame.

2. The vehicle of claim 1 wherein the rail pads are removably attached to the rail clamp.

3. The vehicle of claim 1 wherein the rail clamp further comprises:
a fixed portion and a movable portion; and
a handle coupled to the movable portion.

4. The vehicle of claim 3 wherein the handle of the rail clamp is attached to the movable portion in a cantilevered arrangement.

5. The vehicle of claim 1 wherein the rail clamp further comprises:
a fixed portion and a first and second movable portion;
a handle coupled to the movable portions and including a first pivot coupled at the first movable portion and a second pivot; and
a cantilever attachment coupled between the second pivot and a third pivot at the second movable portion.

6. The vehicle of claim 5 wherein the handle is generally “L” shaped.

7. The vehicle of claim 5 wherein the rail pads are removably attached to respective movable portions.

8. The vehicle of claim 1, further comprising:
one or more side rails coupled to the portion of the frame adjacent the rail clamp.

9. The vehicle of claim 8 wherein the one or more side rails are knurled.

10. The vehicle of claim 9 wherein the rail pads are knurled and structured to interfere with the knurlings on the one or more side rails when the rail clamp is in a closed position.

11. The vehicle of claim 8 wherein the side rails are formed of anodized aluminum.

12. The vehicle of claim 1 wherein the rail pads are formed of aluminum.

13. A rail clamp, comprising:
a rigid body structured to slide longitudinally over a frame when the rail clamp is in an unclamped position;
at least one moveable portion coupled to the body;
a pad coupled to the moveable portion and structured to be pressed against such a frame when the clamp is in a clamped position; and
a handle coupled to the moveable portion and structured to operate from one side of the rigid body.

14. The clamp of claim 13 wherein the pad is removably attached to the moveable portion.

15. The clamp of claim 13 wherein the handle of the rail clamp is attached to the movable portion in a cantilevered arrangement.

16. The clamp of claim 13 wherein the rail clamp further comprises:
a first pivot coupled to a first moveable portion;
a second pivot coupled to a second moveable portion;
a cantilever bracket coupled between the second pivot and a third pivot; and
the handle coupled to both the first pivot and the third pivot.

17. The clamp of claim 13 wherein the movable portion comprises a first and a second portion, and further comprising a second pad coupled to the second moveable portion.

18. The clamp of claim 13 wherein the pad is knurled.

19. The clamp of claim 13 wherein the pad is structured to interface with a non-planer surface of the frame.

20. A bicycle, comprising:
a frame to which wheels are attached;
a seat structure; and
a tilt apparatus coupled to the seat structure; the tilt apparatus attached to the frame and including a tilt adjustment structured to be operated while the bicycle is in motion.

21. The bicycle of claim 20, wherein the tilt apparatus comprises:
a frame having a generally elongated shape and including a pivot end and an end having a slot;
a slider structured to move within the slot; and
a pivot bar having a first end and a second end, the first end coupled to the slider, and the second end structured to be held a fixed distance from the pivot end of the frame.

22. The bicycle of claim 21 wherein the slider has a threaded hole formed therethrough.

23. The bicycle of claim 22, further comprising:
a captured bolt held within the frame and structured to fit within the threaded hole of the slider.

24. The bicycle of claim 21 wherein the slider is aluminum bronze.

25. A seat for a vehicle, comprising:
a frame having horizontal and vertical portions;
a backrest coupled to the vertical portion of the frame;
a seat cushion coupled to a first side of the horizontal portion of the frame; and
a tilting apparatus coupled to a second side of the horizontal portion of the frame, the tilting apparatus further structured to be coupled to the vehicle.

26. The seat of claim 25 wherein the cushion comprises:
a rigid base;
a foam core; and
an air bladder surrounding the foam core.

27. The seat of claim 26, further comprising an air valve coupled to the air bladder and structured to let air enter into or escape from the air bladder.

28. The seat of claim 27, further comprising an outer cover covering the air bladder.

29. The seat of claim 27, wherein the rigid base includes a hole for accepting the air valve therethrough.

30. A steering pivot for a vehicle, comprising:
an upper pivot connected to a steering mechanism;
a lower pivot connected to a steering member;
a connection sleeve inserted within the upper pivot and lower pivot and supporting both pivots;
a bearing slidably coupled to the connection sleeve; and
a friction disk communicating with the connection sleeve and mounted between the upper pivot and the lower pivot.

31. The steering pivot of claim 30, further comprising an engaging mechanism structured to force the upper pivot toward to lower pivot.

32. The steering pivot of claim 31, wherein the engaging mechanism is structured to cause both the upper pivot and the lower pivot to compress opposite surfaces of the friction disk.

33. The steering pivot of claim 30, further comprising a washer disposed between the upper pivot and the friction disk.

34. The steering pivot of claim 30 wherein the steering disk comprises a brake lining material.

35. The steering pivot of claim 30 wherein the bearing comprises a lubricant impregnated polymer.

36. A method of assembling a steering pivot, comprising:
aligning an opening of a first pivot body with an opening of a second pivot body;
placing a friction disk between the aligned openings;
inserting a sleeve through the first pivot body, through the friction disk, and through the second pivot body;
sliding a bearing between an outside surface of the sleeve and an inside surface of one of the pivot bodies; and
forcing the first pivot body toward the second pivot body.

37. The method of claim 36, wherein forcing the first pivot body toward the second pivot body comprises:
attaching a first cap to the first pivot body;
attaching a second cap to the second pivot body;
attaching a threaded member between the first and second caps; and
turning a compression adjuster that is threadedly engaged with the threaded member.

38. The method of claim 36, wherein placing a friction disk comprises placing a friction disk comprising brake lining material between the aligned openings.

39. The method of claim 36 wherein sliding a bearing comprises sliding a polymer bearing between an outside surface of the sleeve and an inside surface of one of the pivot bodies.

40. A vehicle, comprising:
a frame structured to support at least two wheels;
a seat assembly;
a rail clamp attachable to the seat assembly and slidably connected to a portion of the frame, the rail clamp including a pair of rail pads for clamping against the frame;
a tilt mechanism coupled to the seat assembly and to the rail clamp;
the tilt mechanism including a tilt adjustment structured to be operated while the bicycle is in motion; and
a steering pivot including:
a pair of pivots coupled by a connection sleeve,
a bearing slidably coupled to the connection sleeve, and
a friction disk communicating with the connection sleeve and mounted between the pair of pivots.

41. The vehicle of claim 40 wherein the rail clamp includes a cantilever handle.

42. The vehicle of claim 40 wherein the rail pads are positioned to clamp against a set of frame rails that are attached to the frame.

43. The vehicle of claim 40 wherein the rail pads and the frame rails are knurled.
